(19) United States
(12) Patent Application Publication
(10) Pub. No.: US 2014/0368511 A1
(43) Pub. Date: Dec. 18, 2014

(54) INTERACTIVE VISUALIZATION FOR HIGHLIGHTING CHANGE IN TOP AND RELATIVE RANKING

(71) Applicant: Microsoft Corporation, Redmond, WA (US)

(72) Inventors: Patrick J. Baumgartner, Kirkland, WA (US); Amir M. Netz, Bellevue, WA (US); Shahar Prish, Tel-Aviv (IL); Pedram Faghihi Rezaei, Redmond, WA (US)

(21) Appl. No.: 13/919,844

(22) Filed: Jun. 17, 2013

(51) Int. Cl. G06T 13/00

(52) U.S. Cl. CPC G06T 13/00
USPC 345/473

(57) ABSTRACT

Displaying a visualization of ranked elements over a selected dimension. The method includes determining a user selection of a ranking function for a plurality of elements. The ranking function defines a core value to be ranked. The method further includes determining a dimension over which the core value of the ranking function output can change. The method further includes animating a relevant number of the elements over time. A time value of the animation correspond to values of the dimension. Animating includes displaying elements in prominence corresponding to the result of the output of the ranking function.

### BACKGROUND

### Background and Relevant Art

Computers and computing systems have affected nearly every aspect of modern living. Computers are generally involved in work, recreation, healthcare, transportation, entertainment, household management, etc.

Many computers are intended to be used by direct user interaction with the computer. As such, computers have input hardware and software user interfaces to facilitate user interaction. For example, a modern general purpose computer may include a keyboard, mouse, touchpad, camera, etc. for allowing a user to input data into the computer. In addition, various software user interfaces may be available. Examples of software user interfaces include graphical user interfaces, text command line based user interface, function key or hot key user interfaces, and the like.

It may be useful to understand how data item values change with respect to each other over various dimensions.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein is directed to a method practiced in a computing environment. The method includes acts for displaying a visualization of ranked elements over a selected dimension. The method includes determining a user selection of a ranking function for a plurality of elements. The ranking function defines a core value to be ranked. The method further includes determining a dimension over which the core value of the ranking function output can change. The method further includes animating a relevant number of the elements over time. A time value of the animation correspond to values of the dimension. Animating includes displaying elements in prominence corresponding to the result of the output of the ranking function.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1A illustrates a first screen capture of an animation showing ranking of items;

FIG. 1B illustrates a second screen capture of an animation showing ranking of items;

FIG. 1C illustrates a third screen capture of an animation showing ranking of items;

FIG. 1D illustrates a fourth screen capture of an animation showing ranking of items; and

FIG. 2 illustrates a method of displaying a visualization of ranked elements over a selected dimension.

### DETAILED DESCRIPTION

Some embodiments described herein implement an interactive visualization that helps users understand how a ranked set of items changes across one or more variables (such as, but not limited to time). In particular, embodiments may implement an animation that animates a visualization of relative rank of one or more core values of items over a dimension where the animation animates the core values across the dimension by animating the dimension over time. In many examples, the dimension may itself be time. In such cases, an external time will often be correlated to an animated time. For example, time 0:00 s to 1.00 s of the animation represents the time slice for the year 1986. However, the dimension can be almost any variable, but to accomplish the animation, the variable is correlated to time. Embodiments can be particularly useful where it is informative to visualize the relative difference between items in the set for the values being measured to determine the rank.

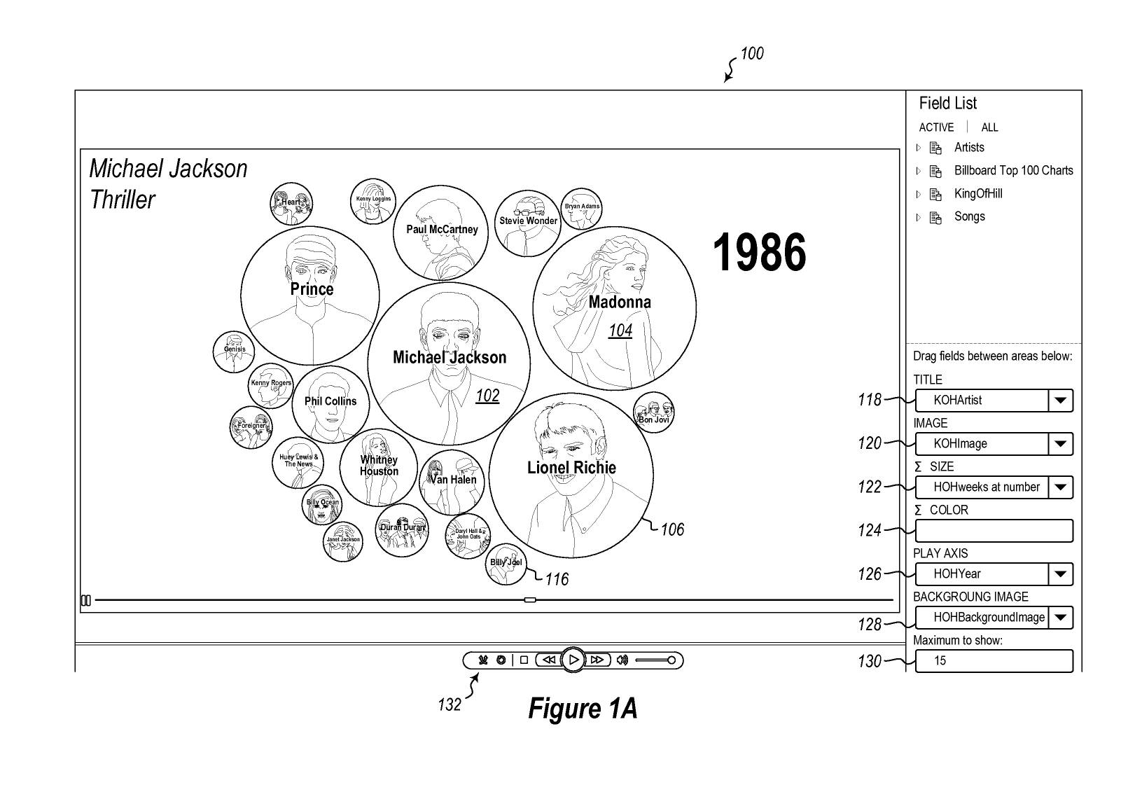

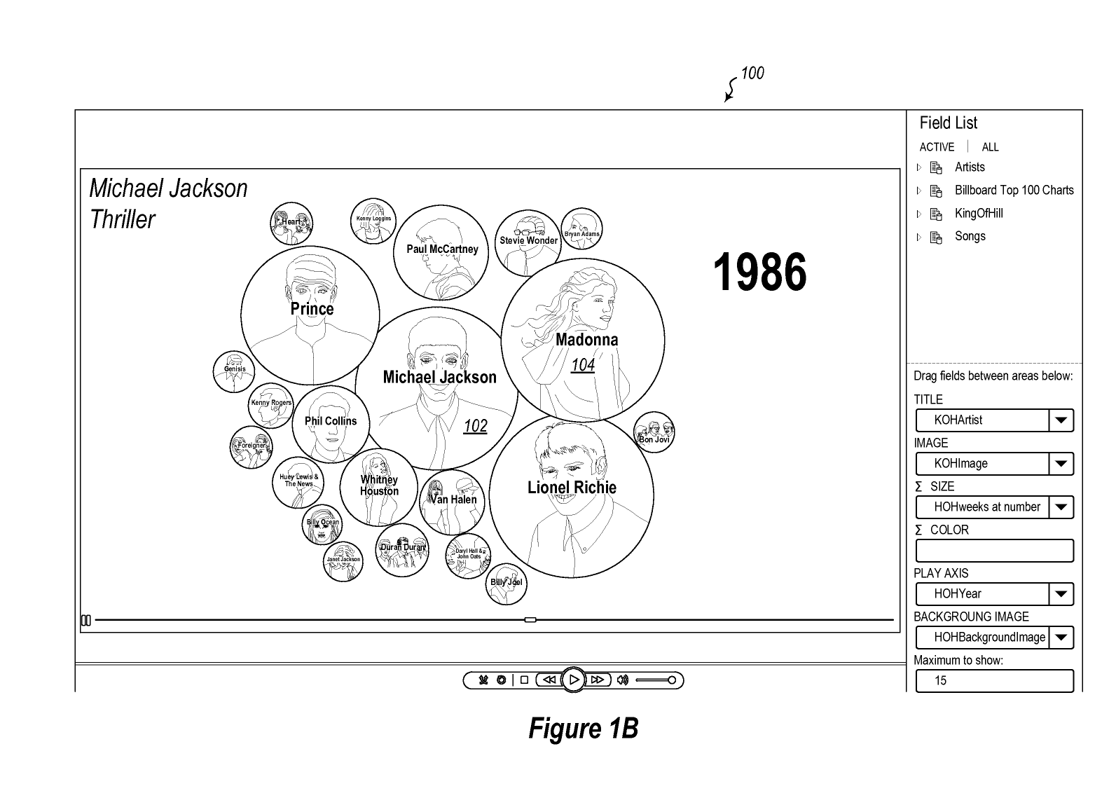

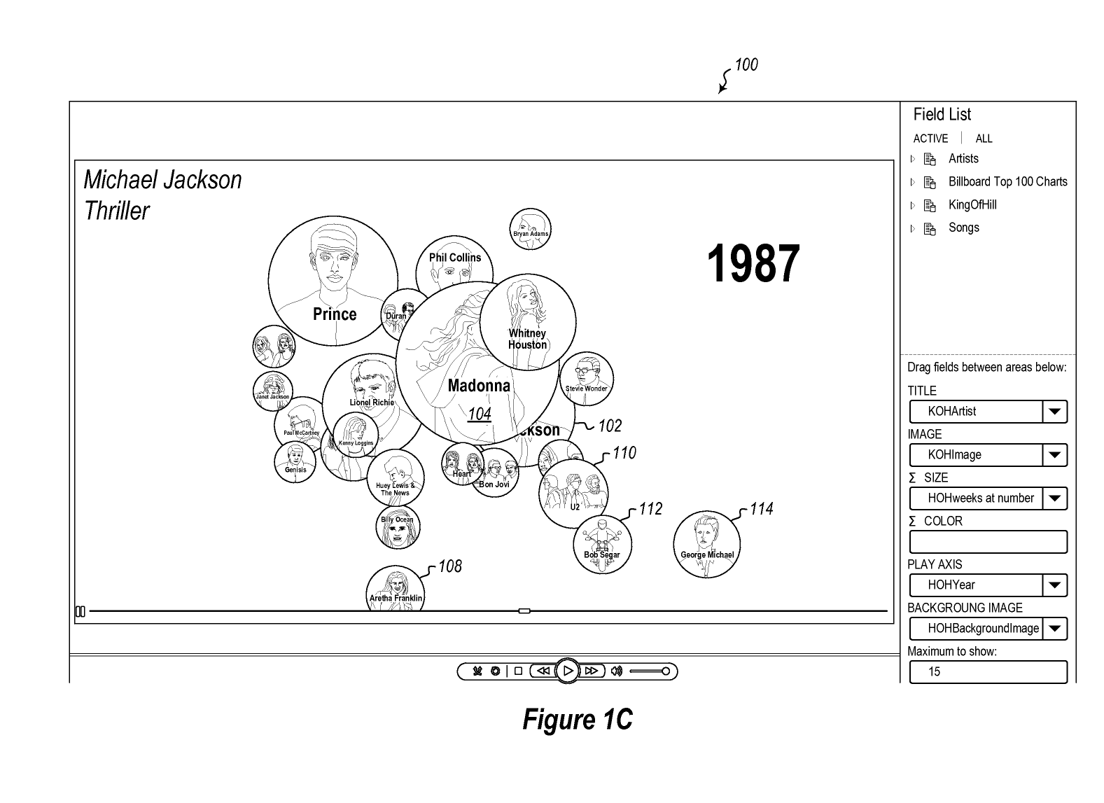

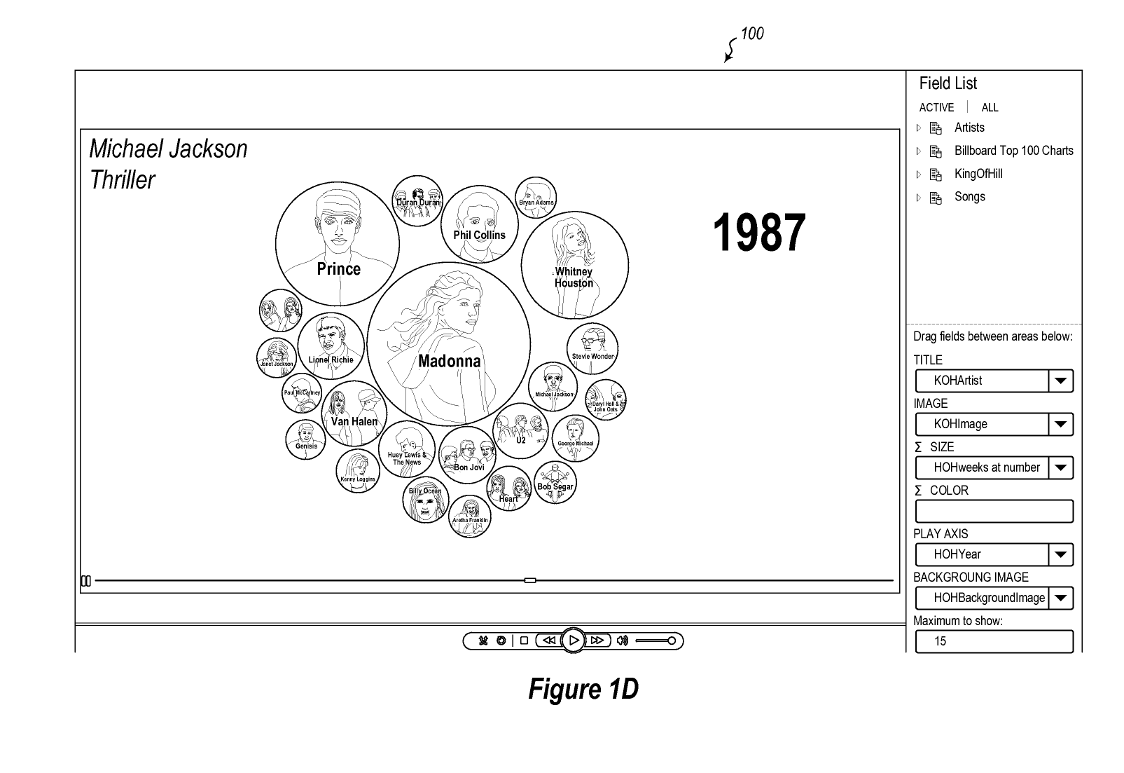

An example is illustrated with respect to FIGS. 1A-1D. These figures illustrate an example where a top selling musical group or artist (as defined by number of weeks at the top of the Billboard 100 chart for the United States of a given year), and relative rank (by weeks at number one in the same year) of other groups or artists in the United States, are shown over years. In particular, animation snapshots of years are shown, where each static snapshot of a year is shown for about 1 second of the animation. Thus, each second in the animation represents a one year static snapshot for the year and short periods of the animation represent transitions between the year snapshots. The figures illustrate captured frames of the animation.

With reference to FIG. 1A, FIG. 1A shows a captured frame of an animation beginning at 1986 and showing the relative rank of artists based on the ranking algorithm described above. This captured frame may be shown statically (i.e. essentially as shown in the captured frame) for about 1 second. In this example, the Michael Jackson item representation 102 is placed in a position of prominence, in this example, in the center of the visualization canvas 100. The item representation 102 is also shown in a size relative to its rank as compared to other items. Thus, a user can quickly see that while Michael Jackson may have been number 1 on the Billboard 100 chart for the most number of weeks, Madonna (as shown by item representation 104) and Lionel Richie (as shown by item representation 106) were number 1 on the Billboard 100 chart for a similar number of weeks. Other artists can be seen to have been number 1 on the chart for relatively fewer numbers of weeks as illustrated by the size of their item representations.

Referring now to FIG. 1B a screen capture is shown illustrating a portions of a transition from 1986 to 1987. In particular, FIG. 1B shows a “bump” action that shows Madonna overtaking Michael Jackson as the top ranked item. In the example, the Madonna item representation 104 moves slightly away from the center of the canvas 100 (not shown), and then move toward the center of the canvas 100, causing a collision and overlap between the Madonna item representation 104 and the Michael Jackson item representation 102. This causes the Michael Jackson item representation 102 to be displaced from its original position.

As illustrated in FIG. 1C, the Michael Jackson item representation 102 resizes and moves to a new position while the Madonna item representation 104 moves to a position of prominence, e.g. the center of the canvas 100.

Additionally, FIG. 1C illustrates that various item representations animate onto the canvas 100 and off of the canvas 100. For example, FIG. 1C illustrates an Aretha Franklin item representation 108 moving onto the canvas 100. FIG. 1C illustrates a U2 item representation 110 moving onto the canvas 100. FIG. 1C illustrates a Bob Segar item representation 112 moving onto the canvas 100. FIG. 1C illustrates a George Michael item representation 114 moving onto the canvas 100. Although not visible in FIG. 1C, examination of FIGS. 1A and 1C shows that the Billy Idol item representation 116 is animated off of the canvas 100.

FIG. 1D illustrates a quiescent point for 1987 where all item representations have settled on the canvas 100 for a period of time to represent portion of the animation which represents a snapshot of ranking for 1987. For example, the screen capture of FIG. 1D may be shown statically as shown for about 1 second. The static display is not required, but rather noted here to illustrate that in some embodiments, a period of animation can correlate to a discrete point of a dimension over which the animation is being performed.

Various embodiments may exhibit various characteristics. For example, some embodiments may provide for a prominent focal point for a top ranked item. For example, FIG. 1A illustrates the Michael Jackson item representation 102 in a position of prominence, i.e. the center of the visualization canvas 100 to show the top item for 1986.

Embodiments may show items relatively sized to show rank. For example, in FIG. 1A all other item representations are sized with respect each other to show how closely they are ranked to each other. In particular, the Michael Jackson item representation 102 is of the largest size, while the Billy Idol item representation 116 shows a much lower ranked item.

Embodiments may implement certain screen placement of items to show relative rank. This may be done in either an absolute way, or a general way that allows for some movement of item representations to provide for a more visually appealing representation. For example, item representations may be arranged to spiral outward as rank decreases such that lower ranked items are further away from the center of the visualization canvas. Alternatively, as is illustrated in FIGS. 1A and 1D, representations may be arranged to generally spiral outward as rank decreases such that lower ranked items are further away from the center of the visualization canvas but when space exists item representations may be located into available free space moving the representations from further away from the center of the canvas 100 to closer to the center of the canvas 100.

Embodiments may implement bumping, or other animation, to show one item taking-over another items as the top ranked item. For example, as illustrated in FIG. 1B, the Madonna item representation 104 “bumps” the Michael Jackson item representation to draw attention to the fact the Madonna is overtaking Michael Jackson as the top ranked artist for 1987.

Embodiments may animate item representations coming into and out of view. For example, FIG. 1C illustrates the Aretha Franklin item representation 108 moving onto the canvas 100. FIG. 1C illustrates the U2 item representation 110 moving onto the canvas 100. FIG. 1C illustrates the Bob Segar item representation 112 moving onto the canvas 100. FIG. 1C illustrates the George Michael item representation 114 moving onto the canvas 100. Although not visible in FIG. 1C, examination of FIGS. 1A and 1C shows that the Billy Idol item representation 116 is animated off of the canvas 100.

User Interface

Some embodiments implement an algorithm for translating input provided by a user and values into visual layout and behavior that highlight change in “top” and “relative” ranking amongst items, where top and relative can be defined by user input. Thus, the visual layout and animation may be determined specifically by what a user determines to be a “top” ranking For example, a user may specify, counter-intuitively, that the artist with lowest number of weeks on the Billboard 100 is the top ranked item. Such a specification by a user would drastically alter how the representations of FIGS. 1A-1C appear and how an animation behaves.

Embodiments may have various features and characteristics, such as an approach for maintaining visual focus on a “top” ranked item. Embodiments may minimize information density within a visualization. Embodiments may visually highlight where changes occur in a consistent manner. Embodiments may provide a consistent and understandable manner for displaying a progression of changes. Embodiments may facilitate user interaction for highlighting specific moments of change.

With reference to the above Figures, an end to end illustration is shown. In particular, one embodiment may implement a design for a visualization that can be broken into several components including:

Input fields/binding of data to visualization elements;

Base visualization construction;

Approach for visualizing change over a variable; and

User interactions.

Input Fields

In one example, a visualization makes use of the following input (such as is illustrated above with reference to FIG. 1A which illustrates user input fields) provided by the user:

A user may specify a title in a title field 118. In particular, the user may specify a “title” table column. This allows the user to specify the list of the items being ranked. For example, in the example illustrated above, a user can specify “musical artist” as the column of items to rank.

A user may optionally specify images in an images field 120. For example, a user may specify an “image” column with a relationship to title column. This allows for a visual representation of an item being ranked. Thus, rather than simply displaying an item with a textual and/or coloring annotation, an actual image may be displayed as part of the item representation. For example, images of album covers or promotional images for the artists may be shown in the item representations.

In the example illustrated a user may specify a “size” element field 122. This is a user specification of a ranking function that specifies how to determine a value for any given title item within a scope. In particular, this is the measure used to rank items. In the example illustrated above, “size” is specified as “weeks at number 1 in last three years”

In the example illustrated a user may optionally specify a color in a color field 124. For example, a user may specify a “color” column with color values as having a relationship to “title” column. This action assigns a color-group to the item representations representing title items based on the values of the specified “color” column. Thus, items in the “title” column can be represented with representations having a corresponding color from the specified color column.

In the example illustrated a user may optionally specify a play axis in a play axis field 126. For example, a user may specify a “play axis” column having a relationship to “title” column. The “play axis” column includes values for the variables (e.g. slices) to view change in ranking over. In the particular example, the play axis is selected to be years. Thus, in this example, slices are illustrated discrete years.

In the example illustrated a user may optionally specify a “maximum items” value in a maximum items field 130. This may be, for example, an integer that defines a maximum number of items to display at any one time. For example, a user may wish to see the top 20 artists compared. This can be accomplished by specifying the “maximum items” value as 20. This number is not necessarily a number of items to display as there may not be sufficient data points to meet the maximum items value, but rather serves as an upper limit, when appropriate.

In the example illustrated a user may optionally specify a background image. For example, a user may specify a “background image” column in a background image field 128 with a relationship to the “play axis” column. This can be used to define images displayed in a background of a visualization (e.g. superimposed on the canvas). This background image may change over a dimension as specified in the “play axis” column and as the images are correlated with the play axis column. For example, in the example illustrated, an image of the top artist for the year may be shown in the background of the canvas during the portions of the animation that represent the year in which that artist was the top artist.

Base Visualization Construction

For a given slice of the play axis, the visual is constructed as follows:

A representation of the item with the largest rank, as determined by the size measure specified in the “size” field 122 by the user is placed in the center (or another prominent position) of the visualization.

A shape (circle in the example illustrated above) is used to represent the item. If an image is specified (such as by specifying an “image” column in the “image” field 120 above correlated to the “title” column) and provided, it is overlaid on the shape. The text name of the item may also be overlaid on the shape. The text name may be identified, in some embodiments, by information in the “title” column. However, the visual styling for elements could be customized without affecting the overall design. The size (e.g. area) of the central item may be determined relative to the size of the overall visualization.

Representations of the next highest ranking items, up to the maximum number of items to show (such as up to the specified “maximum items” field 130) are placed around the representation of the top ranked item. For example, in some embodiments, the representations of items may be placed in an expanding spiral arrangement with lower ranked item representations being placed in an outwardly spiraling fashion. Different layout algorithms could be used to bias for or against overlap, density, or sparsity amongst item representations. For example, in the spiral example, the item representations could be generally placed in a spiraling fashion, but items displayed in a smaller fashion could be used to fill in spaces even though such placement would place them out of the generally spiraling arrangement.

The other item representations that are displayed are sized relative to the largest item representation and the value of the size measure for that item representation. In some embodiments, the difference in size between the item representations could be computed via a logarithmic or other declining function or in absolute terms. A logarithmic function maintains readability in the case of a wide range between the top and lower ranked items. Images and text can be overlaid as with the top ranked item.

If a grouping factor for color is defined (e.g. in the color field 124) the item representations are styled with the color for the group to which the item belongs.

If the play axis is defined (for example, a value is selected in the play axis field 126), the value of a currently selected slice is displayed. For example, as illustrated above, a year slice could be displayed. Optionally the value of size or other metadata for each item could be displayed alongside an item.

If a background image is specified, such as by specifying it in the background image field, the background image is rendered in the background of the canvas 100.

Approach for Visualizing Change Over a Variable

The visualization can be “played” over the column placed on the play axis. This has the effect of creating an animated transition between each slice of the play axis that emphasizes change in ranking

In one example embodiment, the transition animation may be constructed as follows:

If a new item is going to move into the “top” spot a “flourish” animation is played between the two items to indicate them fighting over and changing which items is the top ranked item. For example, as illustrated above, a new top item representation may “bump” a previous top item representation out of the top item position. A simple movement animation could be used or any other animation used to draw attention to a change in the “top” spot.

The new “top” item representation and the old “top” representation are animated to their new sizes and positions based on the base visualization construction rules.

If an item drops out of the maximum number of items to display, its representation is animated off of the visualization canvas 100. If an item is promoted into the range of item representations to display, its representation is animated onto the visualization canvas 100.

The value of the slice for the “play axis” is updated over time as the animation progresses. As illustrated above, the value for the play axis changes from 1986 to 1987. If the image for the background image displayed on the visualization canvas 100 changes, the existing image is animated off the screen and replaced by the new image. This can be done slightly out of phase with the other animations to give a slight parallax effect and is (optionally) used to help segment different periods of time within the play axis. A “play axis” is provided to play a continuous change, stop, or scan through different values for the play axis

User Interactions

A user can interact with the visualization by playing, pausing, or scanning through different values of the play axis. FIG. 1A illustrates play controls 132 that may be implemented to facilitate this functionality.

The user can pivot or swap fields used as the input fields for the visualization. In particular, a user can dynamically, during the animation, change the value of the fields 118, 120, 122, 124, 126, 128 or 130 which will change how the animation is rendered.

Embodiments may include functionality that allows the user to hover over item representations to see related metadata. For example, placing a cursor or pointer over a representation, such as the Michael Jackson representation 102, may allow additional data stored in the database to be displayed in an overlay box, or other representation.

A user can click on an item representation to trigger a drill through/hyperlink action based on the item. For example, clicking on an item representation may cause a browser to navigate to a website. Alternatively or additionally, clicking (or other action such as mousing over, tapping on a touchscreen, etc.) on an item representation may cause additional information about an item to be displayed.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

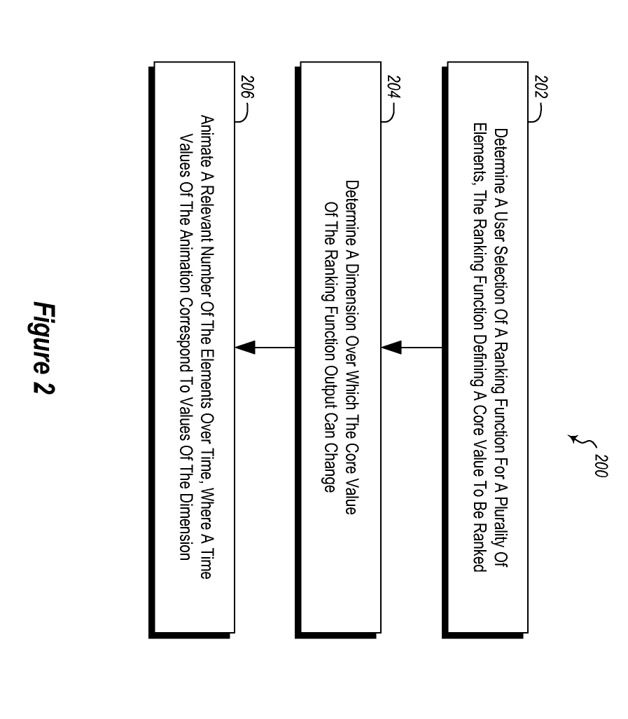

Referring now to FIG. 2, a method 200 is illustrated. The method 200 may be practiced in a computing environment and includes acts for displaying a visualization of ranked elements over a selected dimension. The method includes determining a user selection of a ranking function for a plurality of elements (e.g. the item representations illustrated above), the ranking function defining a core value to be ranked (act 202). In the example illustrated above, a user specifies the function by specifying the value of the size field 122.

The method further includes determining a dimension over which the core value of the ranking function output can change (act 204). In the example illustrated above, this may be based on a user selection of a value of the play axis field 126. Thus, the dimension is years in the example above. However, it should be appreciated that other dimensions, and in particular dimensions other that time may be specified and/or determined. For example, in the music example shown, such dimensions may include genre, label, album, country of origin, etc. Further, embodiments are not limited to music examples, and thus variety of the dimensions could be almost limitless. For example, dimensions may be topics, organizations, locations, species, or any one of a number of almost limitless possibilities.

The method further includes animating a relevant number of the elements over time (act 206). Time values of the animation correspond to values of the dimension. For example, certain time portions of the animation may represent a year value as described above. Animating includes displaying elements in prominence corresponding to the result of the output of the ranking function. Prominence may be indicated by size, position, coloring (such as heat map coloring), item animation (e.g., elements could “vibrate” with more prominent elements vibrating with a greater amplitude), etc. Note that animating elements may include animating representations of elements, such as in the examples above where representations of items are animated.

The method of claim 200 may be practiced where the relevant number of elements is a preselected highest ranked number of elements. For example, FIG. 1A illustrates a maximum items field 130 that can be used by a user to specify a number of elements to be displayed. Such embodiments may further include animating elements coming into and out of the animation based on the preselected relevant number. For example, if an item not shown in one slice of an animation becomes relevant and within the preselected number of highest ranked items, an element representing the item will animate into the visualization while other lower ranked or no longer relevant items will animate out of the visualization. Thus, the method of claim 200 may further include animating elements coming into and out of the animation based on the relevance of the elements.

The method of claim 200 may be practiced where the dimension is time. However, as noted above, various other dimensions could be used. In fact, an almost limitless number of dimensions could be represented.

The method of claim 200 may be practiced where animating comprises showing relative rank of elements by varying the size of the elements. For example, as illustrated above, the item representations in FIGS. 1A-1D show different sizes to illustrate ranking

The method 200 may further include animating one element overtaking another element in prominence by animating interaction between the one element and the another element. For example, FIG. 1B illustrates a “bump” whereby the Madonna item representation 104 overtakes the Michael Jackson item representation 102.

The method 200 may further include showing relative ranking of elements generally based on spatial relation in addition to size. For example, as described above, items may generally spiral outward from a most prominent position.

The method 200 may further include comprising receiving user selection defining how relative ranking is selected and how relative ranking is displayed. For example, as noted above, a user can interact with the user interface elements 118-130 illustrated above to control how the visualization appears.

In some embodiments, the method 200 may further include creating a table and creating the animation from values in the table. In particular, data may be obtained from sources other than a table, or from multiple tables which can then be input into a common/single table that can be used for creating a visualization. In some embodiments, multiple tables may be merged into a single table.

Further, the methods may be practiced by a computer system including one or more processors and computer readable media such as computer memory. In particular, the computer memory may store computer executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer readable storage media and transmission computer readable media.

Physical computer readable storage media includes RAM, ROM, EEPROM, CD-ROM or other optical disk storage (such as CDs, DVDs, etc), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer readable media to physical computer readable storage media (or vice versa). For example, computer-executable instructions or data structures received over a network or data link can be buffered in RAM within a network interface module (e.g., a “NIC”), and then eventually transferred to computer system RAM and/or to less volatile computer readable physical storage media at a computer system. Thus, computer readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment, a method of displaying a visualization of ranked elements over a selected dimension, the method comprising:
determining a user selection of a ranking function for a plurality of elements, the ranking function defining a core value to be ranked;
determining a dimension over which the core value of the ranking function output can change;
animating a relevant number of the elements over time, where time values of the animation correspond to values of the dimension, and wherein animating comprises displaying elements in prominence corresponding to the result of the output of the ranking function.

2. The method of claim 1, wherein the relevant number of elements is a preselected highest ranked number of elements.

3. The method of claim 2, further comprising animating elements coming into and out of the animation based on the preselected relevant number.

4. The method of claim 1, further comprising animating elements coming into and out of the animation based on the relevance of the elements.

5. The method of claim 1, wherein animating comprises showing relative rank of elements by varying the size of the elements.

6. The method of claim 1, further comprising animating one element overtaking another element in prominence by animating interaction between the one element and the another element.

7. The method of claim 1, further comprising showing relative ranking of elements generally based on spatial relation in addition to size

8. The method of claim 1, further comprising receiving user selection defining how relative ranking is selected and how relative ranking is displayed.

9. The method of claim 1, further comprising creating a table and creating the animation from values in the table.

10. A computing system for displaying a visualization of ranked elements over a selected dimension, the system comprising:
one or more processors; and
one or more computer readable media, wherein the one or more computer readable media comprise computer executable instructions that when executed by at least one of the one or more processors cause the system to perform the following:
determining a user selection of a ranking function for a plurality of elements, the ranking function defining a core value to be ranked;
determining a dimension over which the core value of the ranking function output can change;
animating a relevant number of the elements over time, where time values of the animation correspond to values of the dimension, and wherein animating comprises displaying elements in prominence corresponding to the result of the output of the ranking function.

11. The system of claim 10, wherein the relevant number of elements is a preselected highest ranked number of elements.

12. The system of claim 11 wherein the one or more computer readable media comprise computer executable instructions that when executed by at least one of the one or more processors cause the system to animate elements coming into and out of the animation based on the preselected relevant number.

13. The system of claim 10, wherein the one or more computer readable media comprise computer executable instructions that when executed by at least one of the one or more processors cause the system to animate elements coming into and out of the animation based on the relevance of the elements.

14. The system of claim 10, wherein animating comprises showing relative rank of elements by varying the size of the elements.

15. The system of claim 10, wherein the one or more computer readable media comprise computer executable instructions that when executed by at least one of the one or more processors cause the system to animate one element overtaking another element in prominence by animating interaction between the one element and the another element.

16. The system of claim 10, wherein the one or more computer readable media comprise computer executable instructions that when executed by at least one of the one or more processors cause the system to show relative ranking of elements generally based on spatial relation in addition to size

17. The system of claim 10, wherein the one or more computer readable media comprise computer executable instructions that when executed by at least one of the one or more processors cause the system to receive user selection defining how relative ranking is selected and how relative ranking is displayed.

18. The system of claim 10, wherein the one or more computer readable media comprise computer executable instructions that when executed by at least one of the one or more processors cause the system to create a table and creating the animation from values in the table.

19. A physical computer readable storage medium comprising computer executable instructions that when executed by one or more processors causes the following to be performed:
for a predetermined ranking function, the ranking function defining a core value to be ranked, and a dimension over which the core value of the ranking function output can change, animating a relevant number of the elements over time, where time values of the animation correspond to values of the dimension, and wherein animating comprises displaying elements in prominence corresponding to the result of the output of the ranking function including:
displaying higher ranked elements with more prominence in terms of both size and position;
animating elements coming into view and out of view of the animation; and
animating an element taking over another element as a top ranked element by the element bumping the another element causing the another element to move in the animation.

20. The physical computer readable storage medium of claim 19, wherein displaying higher ranked elements with more prominence in terms of both size and position comprises displaying elements in an outwardly spiraling fashion with higher ranked elements closer to the center of the spiral than lower ranked elements.
